(19) United States
(12) Patent Application Publication
(10) Pub. No.: US 2023/0407213 A1
(43) Pub. Date: Dec. 21, 2023

(54) Laundry Composition

(71) Applicant: Conopco, Inc., d/b/a UNILEVER, Englewood Cliffs, NJ (US)

(72) Inventors: Chunhui BAO, Shanghai (CN); Xiaojian CHEN, (US); Siyu DONG, Shanghai (CN); Jun SHEN, Shanghai (CN); Qin YIN, Shanghai (CN)

(73) Assignee: Conopco, Inc., d/b/a UNILEVER, Englewood Cliffs, NJ (US)

(21) Appl. No.: 18/035,829

(22) PCT Filed: Oct. 27, 2021
(86) PCT No.: PCT/EP2021/079745

§ 371 Date: May 8, 2023

(30) Foreign Application Priority Data
Nov. 10, 2020 (WO) PCT/CN2020/127888
Dec. 16, 2020 (EP) 20214397.0

(51) Int. Cl. C11D 17/00; C11D 3/37; C11D 1/14; C11D 1/74; C11D 11/00

(52) U.S. Cl. CPC C11D 17/0008; C11D 3/3765; C11D 3/3788; C11D 1/14; C11D 1/74; C11D 11/0017

(57) ABSTRACT

A concentrated laundry composition which is dilutable in water to form a liquid laundry detergent composition comprising from 10 to 85% by weight of surfactants and from 5 to 9.5% by weight of a grafted copolymer of an acrylic polymer and fatty alcohol alkoxylates or its physiologically acceptable salts, or a mixture thereof. A kit comprising a container comprising said concentrated laundry composition and instructions for use, wherein the instructions comprise the step of diluting one part of the concentrated laundry composition with water, preferably with one to ten parts of water, more preferably with one to five parts of water.

### TECHNICAL FIELD OF THE INVENTION

The present invention relates to dilutable compositions, especially concentrated dilutable laundry compositions. In particular, the present invention relates to concentrated dilutable laundry compositions suitable to be diluted at home by the consumer prior to use.

### BACKGROUND OF THE INVENTION

One of the recent trends for home care is the production of highly concentrated products which can be diluted by the consumer at home to form a working composition suitable for the final use. Such concentrated dilutable products are of great interest to consumers as they provide several advantages. For instance, the products contain lower amounts of water so the volume of the commercial product is significantly reduced, which also reduces the amount of packaging and lowers the costs of transportation and warehouse storage.

Such products are typically purchased as concentrated forms of the regular laundry product and they are diluted by the consumer in their local environment. The immediate challenge is to have the appropriate viscosity of the diluted composition compared with the concentrated product. The diluted composition usually has a viscosity significantly lower than the concentrated product due to the incorporation of water. However, the consumer would expect the diluted composition to have a comparable viscosity to a regular product, and to perform physically as well as functionally as would a regular product.

Despite the prior art, still there remains a need for an improved concentrated dilutable composition which has a viscosity that is satisfactory to the consumer on dilution in water and the resulting diluted composition is behaviourally acceptable to the consumer.

### SUMMARY OF THE INVENTION

In a first aspect, the present invention is directed to a concentrated laundry composition which is dilutable in water to form a liquid laundry detergent composition comprising:
a) from 10 to 85% by weight of surfactants; and
b) from 5 to 9.5% by weight of a grafted copolymer of an acrylic polymer and fatty alcohol alkoxylates, or its physiologically acceptable salts, or a mixture thereof.

In a second aspect, the present invention is directed to a method for forming a liquid laundry detergent composition by diluting one part of a concentrated laundry composition of any embodiment of the first aspect of this invention with water, preferably with one to ten parts of water, more preferably with one to five parts of water.

In a third aspect, the present invention is directed to a kit comprising a container comprising a concentrated laundry composition of any embodiment of the first aspect of this invention and instructions for use, wherein the instructions comprise the step of diluting one part of the concentrated laundry composition with water, preferably with one to ten parts of water, more preferably with one to five parts of water.

In a fourth aspect, the present invention is directed to a kit comprising a container comprising a concentrated laundry composition of any embodiment of the first aspect of this invention in combination with a further keeper container.

All other aspects of the present invention will more readily become apparent upon considering the detailed description and examples which follow.

### DETAILED DESCRIPTION

Except in the examples, or where otherwise explicitly indicated, all numbers in this description indicating amounts of material or conditions of reaction, physical properties of materials and/or use may optionally be understood as modified by the word “about”.

All amounts are by weight of the final composition, unless otherwise specified. It should be noted that in specifying any ranges of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutats mutandis.

Liquid Laundry Detergents

The term “laundry detergent” in the context of this invention denotes formulated compositions intended for and capable of wetting and cleaning domestic laundry such as clothing, linens and other household textiles. The object of the invention is to provide a concentrated laundry composition which on dilution is capable of forming a liquid laundry detergent composition and in the manner now described.

The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines.

The term “liquid” in the context of this invention denotes that a continuous phase or predominant part of the composition is liquid and that the composition is flowable at 15° C. and above. Accordingly, the term “liquid” may encompass emulsions, suspensions, and compositions having flowable yet stiffer consistency, known as gels or pastes. The viscosity of the composition may suitably range from about 200 to about 10,000 mPa-s at 25° C. at a shear rate of 21 sec⁻¹. This shear rate is the shear rate that is usually exerted on the liquid when poured from a bottle. Pourable liquid detergent compositions generally have a viscosity of from 200 to 1,500 mPa-s. Preferably, the viscosity of the concentrated laundry composition is from 300 to 1000 mPa-s and the viscosity of the diluted composition is from 200 to 1500 mPa-s, measured at 25° C. at a shear rate of 21 s⁻¹ by a HAAKE Viscometer.

A concentrated laundry composition according to the invention and also diluted composition may suitably have an aqueous continuous phase. By “aqueous continuous phase” is meant a continuous phase which has water as its basis.

Surfactant

The concentrated laundry composition of the present invention comprises from 10 to 85% by weight of surfactants, preferably from 15 to 60%, more preferably from 20 to 50%, most preferably from 20 to 35%, based on total weight of the concentrated laundry composition and including all ranges subsumed therein. Suitable surfactants comprise anionic surfactants, non-ionic surfactants or mixtures thereof.

Anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of suitable anionic surfactants include, but not limited to, alkyl sulfates, alkyl ether sulfates, alkyl sulfonates, alkaryl sulfonates, alpha-olefin sulfonates, alkyl isethionates, alkanoyl isethionates, alkyl succinates, alkyl sulphosuccinates, alkyl ether sulphosuccinates, N-alkyl sarcosinates, alkyl phosphates, alkyl ether phosphates, alkyl ether carboxylic acids and salts thereof, especially their sodium, magnesium, ammonium and mono-, di-, and triethanolamine salts. The alkyl radicals preferably contain from 10 to 18 carbon atoms and may be unsaturated. The alkyl ether sulphates, alkyl ether sulphosuccinates, alkyl ether phosphates and alkyl ether carboxylic acids and salts thereof may contain from one to twenty ethylene oxide (EO) or propylene oxide (PO) units per molecule.

A preferred class of anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may be used, such as non-ethoxylated primary and secondary alkyl sulphates with an alkyl chain length of from 10 to 18.

Another anionic surfactant commonly used in liquid laundry compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

The concentrated laundry composition may comprise a single anionic surfactant or a mixture of two or more anionic surfactants. Typically, the anionic surfactant is present in an amount of from 10 to 90%, more preferably from 20 to 85% and most preferably from 20 to 50%, based on total weight of the surfactant including all ranges subsumed therein.

Preferably, the composition comprises from 20 to 95% by weight of non-ionic surfactant based on total weight of the surfactant, more preferably from 30 to 90% and most preferably from 50 to 90%. Non-ionic surfactants for use in the invention include, for example, a) polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and alkyl alcohol ethoxylates such as C₈ to C₁₈ primary or secondary linear or branched alcohol ethoxylates with an average of from 2 to 40 moles of ethylene oxide per mole of alcohol; b) fatty acid amides; c) alkoxylated glycerol esters; d) alkyl poly glycosides; e) rhamnolipids; or a mixture thereof.

A preferred class of non-ionic surfactant for use in the present invention includes C₈ to C₁₈ alkyl alcohol ethoxylates, more preferably C₁₂ to C₁₅ primary linear alcohol ethoxylates with an average of from 3 to 20, more preferably from 3 to 10 moles of ethylene oxide per mole of alcohol. Particularly preferred are lauryl alcohol condensed with 3, 5, 7 and 9 moles of EO (AEO-3, AEO-5, AEO-7 and AEO-9).

Another preferred class of non-ionic surfactant for use in the invention includes fatty acid amides. Preferably, the fatty acid amide contains at least 6 carbon atoms. Suitable fatty acid preferably contains from 8 to 24 carbon atoms, preferably from 12 to 20 carbon atoms, and most preferably from 12 to 18 carbon atoms. In the most preferred embodiment of the invention, amides of essential fatty acids are employed. Amides suitable for use in the present invention may be simple amides (i.e., those containing a —CONH₂ group), N-alkyl amides, N, N-dialkyl amides, mono-alkanol amides, and di-alkanol amides. Suitable alkyl or alkanol groups contain from 1 to 30 carbon atoms, preferably from 1 to 20 carbon atoms, and most preferably from 1 to 8 carbon atoms. The preferred amides included in the present invention are mono- and di-alkanol amides, particularly of essential fatty acids. Alkanol amides are more commonly available than alkyl amides.

Preferably, the fatty acid amide is fatty alkanolamides (fatty acid alkanolamides), more preferably C₈ to C₂₀ fatty acid C₁ to C₈ alkanolamide. The preferred fatty acid amides are selected from mono- and diethanolamides of linoleic acid, palmitic acid, and coconut oil. More preferably the fatty acid amide comprises cocamide MEA, cocamide DEA, lauramide DEA, palm kemelamide DEA, stearamide MEA, myristamide DEA, stearamide DEA, oleylamide DEA, tallowamide DEA, tallowamide MEA, isostearamide DEA, isostearamide MEA, cocamide MIPA, or a mixture thereof. Palm kemelamide DEA is particularly preferred.

Another preferred class of non-ionic surfactant is alkoxylated glycerol esters. The alkoxylated glycerol ester is represented by the formula (I):

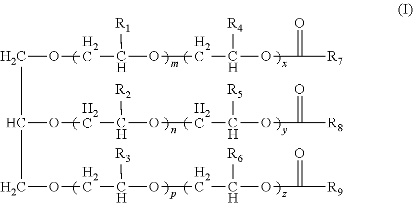

Wherein each of R₁ to R₆ is independently a hydrogen or a methyl group; each of R₇ to R₉ is independently a linear or branched, alkyl or alkenyl group having 5 to 30 carbon atoms, preferably from 8 to 22 carbon atoms, more preferably from 10 to 18 carbon atoms; m, n, p, x, y, or z is independently a number of from 1 to 30, preferably from 5 to 25 and more preferably from 12 to 21. The sum of m, n, p, x, y, z being in the range of 3 to 90.

Preferably, the alkoxylated glycerol ester comprises coconut fatty acid esters. Coconut or coco fatty acids include around 82% wt. saturated fatty acids and of the total fatty acid content lauric acid is the most common at around 48% wt. of the fatty acid content. Myristic acid (16% wt) and palmitic acid (9.5% wt.) are the next most common. Oleic acid is the most common unsaturated acid present at around 6.5% wt. of the fatty acid content.

Preferably, the alkoxylated glycerol ester comprises palm oil fatty acid esters. Palm oil has a balanced fatty acid composition in which the level of saturated fatty acids is almost equal to that of the unsaturated fatty acids. Palmitic acid (44%-45%) and oleic acid (39%-40%) are the major component acids, with linoleic acid (10%-11%) and only a trace amount of linolenic acid. Palm kernel oil contains more saturated fatty acids compared to palm oil. The major fatty acids in palm kernel oil are about 48% lauric acid, 16% myristic acid and 15% oleic acid. The most preferred alkoxylated glycerol ester is palm kernel oil ethoxylates. An example is commercially available under the trade name SOE-N-60 from Sinolight Surfactant Technology Co., Ltd.

Other suitable alkoxylated glyceryl esters are commercially available from Kao under the Levenol brand name. Variants such as Levenol F-200 which has an average EO of 6 and a molar ratio between glycerol and coco fatty acid of 0.55, Levenol V501/2 which has an average EO of 17 and a molar ratio between glycerol and coco fatty acid of 1.5 and Levenol C201 which is also known as glycereth-17 cocoate.

Preferably, the non-ionic surfactant comprises alkyl alcohol ethoxylates, fatty acid alkanolamides, alkoxylated glycerol esters or mixtures thereof.

Preferably, the selection and amount of surfactant is such that the concentrated laundry composition and the diluted composition are isotropic in nature.

Grafted Copolymer

The concentrated laundry composition of the present invention comprises a grafted copolymer of an acrylic polymer and fatty alcohol alkoxylates. Preferably, the acrylic polymer is a homopolymer of acrylic acid. In another preferred embodiment, the acrylic polymer is a copolymer of C₁₀-C₃₀ alkyl acrylate and one or more monomers of acrylic acid, methacrylic acid, or one of their short chain (C₁-C₄ alcohol) esters.

The grafted copolymer can be obtained by grafting the fatty alcohol alkoxylate onto the acrylic polymer backbones. The fatty alcohol alkoxylate is represented by the formula II:

R₁₀O—(CH₂CH₂O)ₐ(CHCH₃CH₂O)_{b}—(CH₂CH₂O)_{c}—H (II)

wherein R₁₀ is a linear or branched, alkyl or alkenyl group having from 10 to 22 carbon atoms, preferably from 12 to 18 carbon atoms; each of a and c is a number of from 0 to 30, preferably from 1 to 15 and more preferably from 1 to 10, b is a number of from 0 to 10, preferably from 0 to 5, more preferably from 0 to 2. The sum of a and c being in the range of from 1 to 30, preferably from 1 to 20, more preferably from 1 to 10.

Preferably, the grafted copolymer is a copolymer of an acrylic polymer and fatty alcohol ethoxylates, which is represented by the formula III:

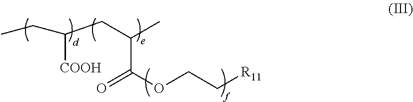

where d is a number of from 1 to 150; e is a number of from 2 to 500, more preferable from 2 to 250; R₁₁ is a linear or branched, alkyl or alkenyl group having from 10 to 22 carbon atoms, preferably from 12 to 18 carbon atoms; f is a number of from 1 to 30, preferably from 1 to 20, more preferably from 1 to 10.

Suitable physiologically acceptable salts of the grafted copolymer include its sodium, magnesium, potassium, ammonium and mono-, di-, and triethanolamine salts. It should be noted that where the grafted copolymer is mentioned in the present disclosure, this also includes the corresponding physiologically acceptable salts thereof, also where not explicitly stated.

The grafted copolymer preferably has a molecular weight of from 1000 to 300,000 g/mol, more preferably from 10000 to 100,000 g/mol. Suitable grafted copolymer for use in the present invention can be prepared by known methods, such as the method disclosed in CN 105154245 A, which is incorporated herein by reference in its entirety.

The concentrated laundry composition of the present invention comprises the grafted copolymer in an amount of from 5 to 9.5% by weight of the composition, preferably from 5.5 to 9.2%, more preferably from 6 to 9%, and most preferably from 6.5 to 9%, based on total weight of the concentrated laundry composition and including all ranges subsumed therein.

The pH of the composition is strictly controlled such that the pH does not change during dilution by the consumer and also provides appropriate phase control during dilution. The pH of the concentrated laundry composition is from 5 to 9 and preferably from 6.0 to 8.5.

Rheology Modifier

The concentrated laundry composition of the present invention may further comprise a rheology modifier in addition to the grafted copolymer which is already included in the composition.

Preferred rheology modifier comprises an ethoxylated sorbitan ester viscosity modifier. The ethoxylated sorbitan ester provides improved rheological characteristics in the context of a product which is diluted by the consumer in the domestic environment. It should be noted that this is independent of any rheological behaviour which is affected by pouring or otherwise using the diluted product. The concentrated laundry composition is to be diluted by the user and as such it is necessary for the concentrated laundry composition to behave rheologically appropriately.

More preferably the ethoxylated sorbitan ester comprises from 50 to 1000 ethoxylate units, more preferably from 200 to 700 and most preferably from 300 to 550.

Preferably, the ethoxylated sorbitan ester comprises one to five, more preferably three to five fatty acid esters. More preferably, the ethoxylated sorbitan ester comprises a fatty acid having from 10 to 22 carbons, more preferably from 14 to 20 and most preferably 18 carbons. The fatty acid may be straight chain or branched, saturated or unsaturated. The most preferred fatty acid group is a stearic acid group.

The most preferred ethoxylated sorbitan ester is sorbeth-450 tristearate and which is the triester of stearic acid and a polyethylene glycol ether of sorbitol with an average of 450 moles of ethylene oxide.

Preferably the ethoxylated sorbitan ester is present at from 0.01 to 8.0% by weight of the concentrated laundry composition.

Preferably, the composition comprises PEG ester fatty acid. PEG fatty acid ester is included top modify the rheological performance of the composition particularly during dilution. Preferred PEG ester fatty acids include PEG 9 cocoate, PEG 32 and PEG 175.

Preferably, the PEG ester fatty acid is present at from 0.01 to 5.0% by weight of the concentrated laundry composition.

Rheology modifiers suitable for use in the present invention are disclosed in VNO 2017/075681

Anti-Foam

The concentrated laundry composition may also comprise an anti-foam. Anti-foam materials are well known in the art and include silicones, fatty acids, fatty alcohols and EO-PO block copolymers.

Preferably, where present, the fatty acid anti-foam is present at from 1.3 to 3.0% by weight of the concentrated laundry composition, more preferably from 1.4 to 2.0% and most preferably from 1.6 to 1.65%.

Suitable fatty acids in the context of this invention include aliphatic carboxylic acids of formula R¹²COOH, where R¹² is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Suitable fatty alcohols in the context of this invention include aliphatic alcohol of formula R¹³OH, where R¹³ is a linear or branched alkyl or alkenyl chain containing from 6 to 24, more preferably 10 to 22, most preferably from 12 to 18 carbon atoms.

Suitable EO-PO block copolymers in the context of this invention include a polymer with repeating units of ethylene oxide and propylene oxide and with hydrophile lipophile balance (HLB) value equal or smaller than 4.

Mixtures of any of the above described materials may also be used.

For formula accounting purposes, in the formulation, fatty acids and/or their salts (as defined above) are not included in the level of surfactant or in the level of builder.

Hydrotropes

A composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included, may be present in an amount ranging from 0.1 to 20%, preferably from 2 to 15%, and more preferably from 10 to 14% (by weight based on the total weight of the concentrated laundry composition). The level of hydrotrope used is linked to the level of surfactant and it is desirable to use hydrotrope level to manage the viscosity in such concentrated laundry compositions. The preferred hydrotrope is monopropylene glycol.

Cosurfactants

A composition of the invention may contain one or more cosurfactants (such as amphoteric (zwitterionic) and/or cationic surfactants) in addition to the surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the concentrated laundry composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

Fluorescent Agents

It may be advantageous to include fluorescent agents in the compositions. Usually, these fluorescent agents are supplied and used in the form of their alkali metal salts, for example, the sodium salts. The total amount of the fluorescent agent or agents used in the composition is generally from 0.005 to 2%, more preferably 0.01 to 0.5% by weight of the concentrated laundry composition.

Preferred classes of fluorescent agents are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescent agents are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

Shading Dyes

Shading dye may be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Shading dyes are well known in the art of laundry liquid formulation.

Suitable and preferred classes of dyes are discussed below.

Direct Dyes:

Direct dyes (otherwise known as substantive dyes) are the class of water soluble dyes which have an affinity for fibres and are taken up directly. Direct violet and direct blue dyes are preferred.

Preferably bis-azo or tris-azo dyes are used.

Most preferably, the direct dye is a direct violet of the following structures:

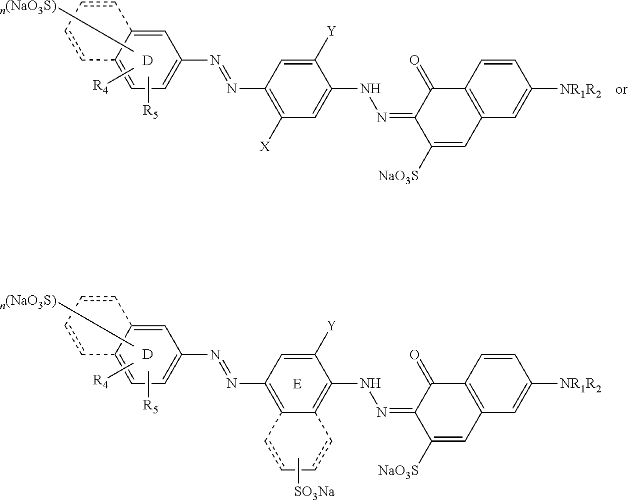

wherein:
ring D and E may be independently naphthyl or phenyl as shown;
R₁ is selected from: hydrogen and C₁-C₄-alkyl, preferably hydrogen;
R₂ is selected from: hydrogen, C₁-C₄-alkyl, substituted or unsubstituted phenyl and substituted or unsubstituted naphthyl, preferably phenyl;
R₃ and R₄ are independently selected from: hydrogen and C₁-C₄-alkyl, preferably hydrogen or methyl;
X and Y are independently selected from: hydrogen, C₁-C₄-alkyl and C₁-C₄-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes for example direct violet 66 may be used. The benzidene based dyes are less preferred.

Preferably the direct dye is present at 0.000001 to 1%, more preferably 0.00001% to 0.0010% by weight of the composition.

In another embodiment the direct dye may be covalently linked to the photo-bleach, for example as described in WO2006/024612.

Acid Dyes:

Cotton substantive acid dyes give benefits to cotton containing garments. Preferred dyes and mixes of dyes are blue or violet. Preferred acid dyes are:
(i) azine dyes, wherein the dye is of the following core structure:

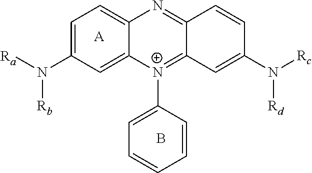

wherein Rₐ, R_{b}, R_{c} and R_{d} are selected from: H, a branched or linear C₁ to C₇-alkyl chain, benzyl a phenyl, and a naphthyl;
the dye is substituted with at least one SO₃; or —COO⁻ group;
the B ring does not carry a negatively charged group or salt thereof; and
the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005% to 0.01% by weight of the composition.

Hydrophobic Dyes:

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001% to 0.005% by weight of the composition.

Basic Dyes:

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

Reactive Dyes:

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species for example a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

Dye Conjugates:

Dye conjugates are formed by binding direct, acid or basic dyes to polymers or particles via physical forces. Dependent on the choice of polymer or particle they deposit on cotton or synthetics. A description is given in WO2006/055787.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

Shading dye can be used in the absence of fluorescent agents, but it is especially preferred to use a shading dye in combination with a fluorescent agent, for example in order to reduce yellowing due to chemical changes in adsorbed fluorescent agents.

Builders

A composition of the invention may contain one or more builders. Builders enhance or maintain the cleaning efficiency of the surfactant, primarily by reducing water hardness.

This is done either by sequestration or chelation (holding hardness minerals in solution), by precipitation (forming an insoluble substance), or by ion exchange (trading electrically charged particles).

Builders for use in the invention can be of the organic or inorganic type, or a mixture thereof.

Suitable inorganic builders include hydroxides, carbonates, sesquicarbonates, bicarbonates, silicates, zeolites, and mixtures thereof. Specific examples of such materials include sodium and potassium hydroxide, sodium and potassium carbonate, sodium and potassium bicarbonate, sodium sesquicarbonate, sodium silicate and mixtures thereof.

Suitable organic builders include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Mixtures of any of the above described materials may also be used.

Builder, when included, may be present in an amount ranging from about 0.1 to about 20%, preferably from about 0.5 to about 15%, more preferably from about 1 to about 10% (by weight based on the total weight of the composition).

Preferably this builder is methyl glycine diacetic acid (MGDA). We have surprisingly found that the MGDA provides a wider formulation window for this unusual product format and permits more anti-foam without diminishing the visual appeal, in particular the clarity, of the product before dilution by the consumer. This is particularly the case when the composition also comprises a fatty acid anti-foam.

Where present, the MGDA is present at from 0.1 to 3% by weight of the concentrated laundry composition, preferably from 0.1 to 2 and more preferably from 0.2 to 1.0% by weight of the concentrated laundry composition. Preferably, the concentrated laundry composition comprises less than 1% by weight HEDP (an abbreviation for Etidronic acid or 1-hydroxyethane 1,1-diphosphonic acid) sequestrant, more preferably less than 0.1% by weight of HEDP sequestrant.

While the composition of the invention may comprise MGDA, it is preferred that no other builder is present. Accordingly, compositions of the invention may contain from 0 to 1%, more preferably from 0 to 0.1% wt. concentrated laundry composition one or more additional builders.

Soil Release Polymers

Soil release polymers (SRP) help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (IV):

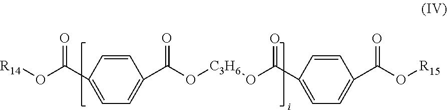

in which R₁₄ and R₁₅ independently of one another are X—(OC₂H₄)_{q}—(OC₃H₆)ₛ;
in which X is C₁₄ alkyl and preferably methyl;
q is a number from 12 to 120, preferably from 40 to 50;
s is a number from 1 to 10, preferably from 1 to 7; and
i is a number from 4 to 9.

Because they are averages, q, s and i are not necessarily whole numbers for the polymer in bulk.

Mixtures of any of the above described materials may also be used.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable SRPs are described in greater detail in U.S. Pat. Nos. 5,574,179; 4,956,447; 4,861,512; 4,702,857, VNO 2007/079850 and WO2016/005271. If employed, SRPs will typically be incorporated into the concentrated laundry composition herein in concentrations ranging from 0.01 to 10%, more preferably from 0.1 to 5% by weight of the concentrated laundry composition.

Polymeric Cleaning Boosters

To further improve the environmental profile of liquid laundry detergents it may be preferred in some cases to reduce the volume of laundry detergent dosed per wash-load and to add various highly weight efficient ingredients to the composition to boost cleaning performance. In addition to the soil release polymers of the invention described above, a composition of the invention will preferably contain one or more additional polymeric cleaning boosters such as anti-redeposition polymers.

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above described materials may also be used.

When included, a composition of the invention will preferably comprise such materials from 0.025 to 8% by weight of the concentrated laundry composition depending on the parts concentrated laundry composition are intended to be mixed with water. An amount that provides from 0.5 to 6% (by weight based on the total weight of the diluted composition) of one or more anti-redeposition polymers such as, for example, the alkoxylated polyethyleneimines which are described above.

Polymeric Thickeners

A composition of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise the polymeric thickeners from 0.01 to 5% by weight of the concentrated laundry composition but depending on the amount intended for use in the final diluted composition and which is desirably from 0.1 to 3% by weight based on the total weight of the diluted composition.

External Structurants

Compositions of the invention may have their rheology further modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

Enzymes

A composition of the invention may comprise an effective amount of one or more enzyme selected from the group comprising pectate lyase, protease, amylase, cellulase, lipase, mannanase and mixtures thereof. The enzymes are preferably present with corresponding enzyme stabilizers.

Fragrances

Fragrances are well known in the art and may be incorporated into compositions described herein.

Microcapsules

One type of microparticle suitable for use in the invention is a microcapsule. Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material.

Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Alternatively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography.

Polymeric core-shell microcapsules for use in the invention may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future microcapsule and the dimensions of the dispersed droplets directly determine the size of the subsequent microcapsules. Microcapsule shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell microcapsules. An example of a core-shell microcapsule produced by this method is a polyurea microcapsule with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed core material to produce a coherent film and the desired microcapsules. An example of a core-shell microcapsule produced by this method is an aminoplast microcapsule with a shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

One example of a preferred polymeric core-shell microcapsule for use in the invention is an aminoplast microcapsule with an aminoplast shell surrounding a core containing the fragrance formulation (f2). More preferably such an aminoplast shell is formed from the polycondensation product of melamine with formaldehyde.

Polymeric microparticles suitable for use in the invention will generally have an average particle size between 100 nanometers and 50 microns. Particles larger than this are entering the visible range. Examples of particles in the sub-micron range include latexes and mini-emulsions with a typical size range of 100 to 600 nanometers. The preferred particle size range is in the micron range. Examples of particles in the micron range include polymeric core-shell microcapsules (such as those further described above) with a typical size range of 1 to 50 microns, preferably 5 to 30 microns. The average particle size can be determined by light scattering using a Malvern Mastersizer with the average particle size being taken as the median particle size D (0.5) value. The particle size distribution can be narrow, broad or multimodal. If necessary, the microcapsules as initially produced may be filtered or screened to produce a product of greater size uniformity.

Polymeric microparticles suitable for use in the invention may be provided with a deposition aid at the outer surface of the microparticle. Deposition aids serve to modify the properties of the exterior of the microparticle, for example to make the microparticle more substantive to a desired substrate. Desired substrates include cellulosics (including cotton) and polyesters (including those employed in the manufacture of polyester fabrics).

The deposition aid may suitably be provided at the outer surface of the microparticle by means of covalent bonding, entanglement or strong adsorption. Examples include polymeric core-shell microcapsules (such as those further described above) in which a deposition aid is attached to the outside of the shell, preferably by means of covalent bonding. While it is preferred that the deposition aid is attached directly to the outside of the shell, it may also be attached via a linking species.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of β1-4 linked glucose residues), a mannan backbone (consisting of β1-4 linked mannose residues) or a xylan backbone (consisting of β1-4 linked xylose residues). Examples of such β1-4 linked polysaccharides include xyloglucans, glucomannans, mannans, galactomannans, β(1-3),(1-4) glucan and the xylan family incorporating glucurono-, arabino- and glucuronoarabinoxylans. Preferred β1-4 linked polysaccharides for use in the invention may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as loc ust bean gum (LBG) (which has a mannan backbone of β1-4 linked mannose residues, with single unit galactose side chains linked α1-6 to the backbone).

Also suitable are polysaccharides which may gain an affinity for cellulose upon hydrolysis, such as cellulose mono-acetate; or modified polysaccharides with an affinity for cellulose such as hydroxypropyl cellulose, hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

Deposition aids for use in the invention will generally have a weight average molecular weight (M₂) in the range of from about 5 kDa to about 500 kDa, preferably from about 10 kDa to about 500 kDa and more preferably from about 20 kDa to about 300 kDa.

One example of a particularly preferred polymeric core-shell microcapsule for use in the invention is an aminoplast microcapsule with a shell formed by the polycondensation of melamine with formaldehyde; surrounding a core containing the fragrance formulation (f2); in which a deposition aid is attached to the outside of the shell by means of covalent bonding. The preferred deposition aid is selected from β1-4 linked polysaccharides, and in particular the xyloglucans of plant origin, as are further described above.

The present inventors have surprisingly observed that it is possible to reduce the total level of fragrance included in the composition of the invention without sacrificing the overall fragrance experience delivered to the consumer at key stages in the laundry process. A reduction in the total level of fragrance is advantageous for cost and environmental reasons.

Accordingly, the total amount of fragrance formulation (f1) and fragrance formulation (f2) in the concentrated laundry composition of the invention suitably ranges from 0.5 to 1.4%, preferably from 0.5 to 1.2%, more preferably from 0.5 to 1% and most preferably from 0.6 to 0.9% (by weight based on the total weight of the concentrated laundry composition).

The weight ratio of fragrance formulation (f1) to fragrance formulation (f2) in the composition of the invention preferably ranges from 60:40 to 45:55. Particularly good results have been obtained at a weight ratio of fragrance formulation (f1) to fragrance formulation (f2) of around 50:50.

The fragrance (f1) and fragrance (f2) are typically incorporated at different stages of formation of the composition of the invention. Typically, the discrete polymeric microparticles (e.g. microcapsules) entrapping fragrance formulation (f2) are added in the form of a slurry to a warmed base formulation comprising other components of the composition (such as surfactants and solvents). Fragrance (f1) is typically post-dosed later after the base formulation has cooled.

Further Optional Ingredients

A composition of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, anti-oxidants, sunscreens, anti-corrosion agents, drape imparting agents, anti-static agents, sequestrants, ironing aids, colorants, pearlisers and/or opacifiers. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

Many of the ingredients used in embodiments of the invention may be obtained from so called black carbon sources or a more sustainable green source. The following provides a list of alternative sources for several of these ingredients and how they can be made into raw materials described herein.

SLES and PAS

SLES and other such alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol. Accordingly, forming the linear alcohol is a central step in obtaining both PAS and alkali-metal alkyl ether sulphate surfactants.

The linear alcohols which are suitable as an intermediate step in the manufacture of alcohol ethoxylates and therefore anionic surfactants such as sodium lauryl ether sulphate ca be obtained from many different sustainable sources. These include: Primary sugars Primary sugars are obtained from cane sugar or sugar beet, etc., and may be fermented to form bioethanol. The bioethanol is then dehydrated to form bio-ethylene which then undergoes olefin methathesis to form alkenes. These alkenes are then processed into linear alcohols either by hydroformylation or oxidation.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

Biomass

Biomass, for example forestry products, rice husks and straw to name a few may be processed into syngas by gasification. Through a Fischer Tropsch reaction these are processed into alkanes, which in turn are dehydrogenated to form olefins. These olefins may be processed in the same manner as the alkenes described above [primary sugars]. An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

Waste Plastics

Waste plastic is pyrolyzed to form pyrolysed oils. This is then fractioned to form linear alkanes which are dehydrogenated to form alkenes. These alkenes are processed as described above [primary sugars].

Alternatively, the pyrolyzed oils are cracked to form ethylene which is then processed to form the required alkenes by olefin metathesis. These are then processed into linear alcohols as described above [primary sugars].

Municipal Solid Waste

MSW is turned into syngas by gasification. From syngas it may be processed as described above [primary sugars] or it may be turned into ethanol by enzymatic processes before being dehydrogenated into ethylene. The ethylene may then be turned into linear alcohols by the Ziegler Process.

The MSW may also be turned into pyrolysis oil by gasification and then fractioned to form alkanes. These alkanes are then dehydrogenated to form olefins and then linear alcohols.

Marine Carbon

There are various carbon sources from marine flora such as seaweed and kelp. From such marine flora the triglycerides can be separated from the source and which is then hydrolysed to form the fatty acids which are reduced to linear alcohols in the usual manner. Alternatively, the raw material can be separated into polysaccharides which are enzymatically degraded to form secondary sugars. These may be fermented to form bioethanol and then processed as described above [Primary Sugars].

Waste Oils

Waste oils such as used cooking oil can be physically separated into the triglycerides which are split to form linear fatty acids and then linear alcohols as described above.

Alternatively, the used cooking oil may be subjected to the Neste Process whereby the oil is catalytically cracked to form bio-ethylene. This is then processed as described above.

Methane Capture

Methane capture methods capture methane from landfill sites or from fossil fuel production. The methane may be formed into syngas by gasification. The syngas may be processed as described above whereby the syngas is turned into methanol (Fischer Tropsch reaction) and then olefins before being turned into linear alcohols by hydroformylation oxidation.

Alternatively, the syngas may be turned into alkanes and then olefins by Fischer Tropsch and then dehydrogenation.

Carbon Capture

Carbon dioxide may be captured by any of a variety of processes which are all well known. The carbon dioxide may be turned into carbon monoxide by a reverse water gas shift reaction and which in turn may be turned into syngas using hydrogen gas in an electrolytic reaction. The syngas is then processed as described above and is either turned into methanol and/or alkanes before being reacted to form olefins.

Alternatively, the captured carbon dioxide is mixed with hydrogen gas before being enzymatically processed to form ethanol. This is a process which has been developed by Lanzatech. From here the ethanol is turned into ethylene and then processed into olefins and then linear alcohols as described above.

LAS

One of the other main surfactants commonly used in cleaning compositions, in particular laundry compositions is LAS (linear alkyl benzene sulphonate).

The key intermediate compound in the manufacture of LAS is the relevant alkene. These alkenes (olefins) may be produced by any of the methods described above and may be formed from primary sugars, biomass, waste plastic, MSW, carbon capture, methane capture, marine carbon to name a few.

Whereas in the processed described above the olefin is processed to form linear alcohols by hydroformylation and oxidation instead, the olefin is reacted with benzene and then sulphonate to form the LAS.

Packaging and Dosing

A composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of laundering fabric using a composition of the invention will usually involve diluting the dose of concentrated composition with water to obtain a wash liquor, and washing fabrics with the wash liquor so formed.

The consumer may add water to the concentrated laundry composition, or alternatively concentrated laundry composition to the water depending on the preferred consumer behaviour in any particular market. Where the concentrated laundry composition is added to water, the concentrated laundry composition is made available to the consumer in a regular pack conforming with the volume of the concentrated laundry composition purchased. In such instances it is preferred that the packaged concentrated laundry composition is available with an appropriately dimensioned dilution container in which water is added from a domestic supply and to which the concentrated laundry composition is added to form the functional liquid detergent composition.

Preferably, the dilution ratio with water is from 0.8:1 to 10:1 (water to the concentrated laundry composition). The dilution ratio is also dependent on market choice. In some markets a more concentrated product is desired while in others a more dilute product is preferred. The amount of water instructed to be used is thus variable but it is preferred that the dilution is at least 1:1 and preferably no more than 5 to 1, water to the concentrated laundry composition.

Preferably there is provided a container comprising the concentrated laundry composition of the present invention. Containers include bottles, totties, sealable bags and doy-packs and such like. Preferably, the container has an orifice which may provide means for adding water from a domestic supply to the container containing a concentrated composition. It is also preferred that the container comprises a means for adding water to the container and a separate means for permitting diluted contents to be dispensed. In such an embodiment the means for adding water is preferably near the top of the container when in a standing disposition and the means for permitting diluted contents to be dispensed is disposed near the bottom in the same disposition.

The container may also be of an expansible type wherein the container as purchased by the consumer is to be expanded before dilution with water from a domestic supply.

For example, the consumer purchases a container which is folded such that it contains a first volume of concentrated composition and is optionally packaged within a secondary package such that the consumer sees only a regular box or carton. Inside such secondary pack is a bag or other such container and which contains the concentrated composition.

Water is added from a domestic supply and the concentrated composition is thus diluted to form the liquid laundry treatment composition which can be used in a regular way by the consumer. For example, it may be added to a shuttle device and placed inside a washing machine drum or it may be dispensed into a washing machine drawer.

The water supplied may also be filtered prior to use. This is at the consumer's discretion but it is expected that the concentrated laundry composition described herein is suitable for a wide variety of water hardnesses.

Preferably, the container displaces a volume appropriate to permit dilution of said concentrated laundry composition to form a liquid laundry detergent composition at an appropriate dilution. For example, container may have internal volume (V) and the concentrated laundry composition supplied in the container may have volume V/3. In such an embodiment the consumer will be directed to add two parts of water to one part of the concentrated laundry composition such that the volume of diluted composition is substantially equal to V.

In an alternative embodiment the concentrated laundry composition is marketed in a container of appropriate size to match the volume sold, together with a ‘keeper’ container which can be sold filled with diluted product or empty as the consumer prefers. The concentrated laundry composition container and the keeper container are maintained together by a form of secondary wrapping such as shrink wrap.

The keeper may have a marker assisting the user in achieving the correct dilution levels.

The following examples are provided to facilitate an understanding of the present invention. The examples are not provided to limit the scope of the claims.

### EXAMPLES

### Example 1

This example demonstrates the effect of grafted copolymers on the viscosity of the concentrated laundry composition before and after dilution with water. All ingredients are expressed by weight percent of the total formulation.

TABLE 1

| | Samples | | | |
|---|---|---|---|---|
| Ingredient | 1 | 2 | 3 | 4 |
| Sodium chloride | 1.2 | 1.2 | 1.2 | 1.2 |
| Water | Balance | Balance | Balance | Balance |
| Sodium hydroxide | 4.96 | 5.35 | 5.90 | 6.08 |
| (32%) | | | | |
| Propylene glycol | 8 | 8 | 8 | 8 |
| Fatty alcohol | 8 | 8 | 8 | 8 |
| ethoxylates | | | | |
| Palm kernelamide | 10 | 10 | 10 | 10 |
| DEA | | | | |
| Linear alkylbenzene | 10 | 10 | 10 | 10 |
| sulfonate | | | | |
| Palm kernel oil | 12 | 12 | 12 | 12 |
| ethoxylates | | | | |
| Thixome S-9^{a} | 8.5 | 12 | 16 | 18 |
| Preservative | 0.225 | 0.225 | 0.225 | 0.225 |
| Perfume | 1 | 1 | 1 | 1 |

^{a}Commercial grafted copolymer of an acrylic polymer and fatty alcohol ethoxylates under the trade name Thixome S-9 from Guangzhou tinci materials technology Co., Ltd, which contains 55% by weight of the grafted copolymer active.

Results

Samples 1 to 4 are concentrated formulations. 5× dilution sample was prepared by diluting one part of concentrated formulation with four parts of water. In this example, 20 grams of concentrated formulation was added to a bottle containing 80 grams of water, the bottle was then shaken upside down for the mixture to mix homogeneously.

The viscosity of a sample was measured at room temperature (25° C.) at shear rate of 21 s⁻¹ with a HAAKE VT550 Viscometer, measurement rotor MV2. The viscosities of the samples before and after 5× dilution was reported in table 2.

TABLE 2

| | Samples | | | |
|---|---|---|---|---|
| Viscosity/mPa · s | 1 | 2 | 3 | 4 |
| As prepared | 344 | 462 | 644 | 693 |
| 5x dilution | 173 | 409 | 836 | 1305 |

The viscosity of a laundry composition ranging from 200 to 1500 mPa-s is taken as acceptable. The viscosity difference of a concentrated laundry composition before and after dilution no greater than 300 to 400 mPa-s is considered as acceptable. In other words, it is assumed that the consumer would not perceive the differences in viscosities between a concentrated composition and a diluted composition when the viscosity differences of the two are within this range.

Samples 2 and 4 comprised the grafted copolymer at a level of 6.6% and 8.8% respectively. As shown in table 2, samples 2 and 4 had acceptable viscosities before and after dilution. The viscosity differences of samples 2 to 4 before and after dilution were also within the acceptable range.

1. A concentrated laundry composition which is dilutable in water to form a liquid laundry detergent composition comprising:
a) from 10 to 85% by weight of surfactants and
b) from 5 to 9.5% by weight of a grafted copolymer of an acrylic polymer and fatty alcohol alkoxylates, or its physiologically acceptable salts, or a mixture thereof.

2. The concentrated laundry composition according to claim 1, wherein the acrylic polymer is a homopolymer of acrylic acid.

3. The concentrated laundry composition according to claim 1, wherein the acrylic polymer is a copolymer of C₁₀-C₃₀ alkyl acrylate and one or more monomers of acrylic acid, methacrylic acid, or one of their short chain (C₁-C₄ alcohol) esters.

4. The concentrated laundry composition according to claim 1, wherein the fatty alcohol alkoxylate is represented by the formula (II):
R₁₀O—(CH₂CH₂O)ₐ—(CHCH₃CH₂O)_{b}—(CH₂CH₂O)_{c}—H (II)
wherein R₁₀ is a linear or branched, alkyl or alkenyl group having from 10 to 22 carbon atoms, preferably from 12 to 18 carbon atoms; each of a and c is a number of from 0 to 30, preferably from 1 to 15 and more preferably from 1 to 10, b is a number of from 0 to 10, preferably from 0 to 5, more preferably from 0 to 2; the sum of a and c being in the range of from 1 to 30, preferably from 1 to 20, more preferably from 1 to 10.

5. The concentrated laundry composition according to claim 1, wherein the grafted copolymer is represented by formula (III): 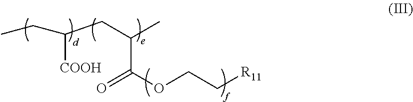
where d is a number of from 1 to 150; e is a number of from 2 to 500, more preferable from 2 to 250; R₁₁ is a linear or branched, alkyl or alkenyl group having from 10 to 22 carbon atoms, preferably from 12 to 18 carbon atoms; f is a number of from 1 to 30, preferably from 1 to 20, more preferably from 1 to 10.

6. The concentrated laundry composition according to claim 1, wherein the composition comprises the grafted copolymer in an amount of from 5.5 to 9.2% by weight of the composition, preferably from 6 to 9%.

7. The concentrated laundry composition according to claim 1, wherein the composition comprises from 15 to 60% by weight of surfactants, preferably from 20 to 50%.

8. The concentrated laundry composition according to claim 1, wherein the surfactant comprises anionic surfactants, preferably linear alkyl benzene sulfonates.

9. The concentrated laundry composition according to claim 8, wherein the anionic surfactant is present in an amount of from 10 to 90% by total weight of the surfactant, preferably from 20 to 85%.

10. The concentrated laundry composition according to claim 1, wherein the surfactant comprises non-ionic surfactants comprising alkyl alcohol ethoxylates, fatty acid alkanolamides, alkoxylated glycerol esters or mixtures thereof.

11. The concentrated laundry composition according to claim 10, wherein the non-ionic surfactant comprises alkoxylated glycerol ester.

12. The concentrated laundry composition according to claim 10, wherein the non-ionic surfactant is present in an amount of from 20 to 95% by total weight of the surfactant.

13. The concentrated laundry composition according to claim 1, wherein the composition has a viscosity of from 300 to 1000 mPa-s measured at 25° C. at a shear rate of 21 s⁻¹ by a HAAKE Viscometer.

14. A kit comprising a container comprising a concentrated laundry composition according to claim 1 and instructions for use, wherein the instructions comprise the step of diluting one part of the concentrated laundry composition with one to ten parts of water.

15. A The kit comprising a container comprising a concentrated laundry composition according to claim 13 in combination with a further keeper container.

16. The concentrated laundry composition according to claim 10, wherein the non-ionic surfactant is palm kernel oil ethoxylates.

17. The concentrated laundry composition according to claim 10, wherein the non-ionic surfactant is present in an amount of from 30 to 90% by total weight of the surfactant.

18. The kit comprising a container comprising a concentrated laundry composition according to 14 wherein the instructions comprise the step of diluting one part of the concentrated laundry composition with one to five parts of water.
